(19) United States
(12) Patent Application Publication
(10) Pub. No.: US 2005/0233602 A1
(43) Pub. Date: Oct. 20, 2005

(54) Serial advanced technology attachment connector that can be mounted on an edge of a printed circuit board

(76) Inventor: Michael A. Link, Cornelius, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/827,796

(22) Filed: Apr. 19, 2004

(51) Int. Cl. H01R 13/15

(52) U.S. Cl. 439/59

(57) ABSTRACT

A connector is provided, having a connector body, a first plurality of contacts, and a second plurality of contacts. The connector body has upper, lower, front, back, left, and right surfaces. The first plurality of contacts are secured to the connector body. Each of the first plurality of contacts has a surface at the back surface of the connector body, the surface of the first contact having a curved portion between planes of the upper and lower surfaces of the connector body. Each one of the second plurality of contacts is secured to the connector body and electrically connected to the first plurality of contacts. Each one of the second plurality of contacts has a surface at the front surface of the connector body, and is depressible against a spring force when making contact with a respective edge finger connector on a board.

### BACKGROUND OF THE INVENTION

1). Field of the Invention

This invention relates to a connector and to a computer subassembly with such a connector.

2). Discussion of Related Art

A computer assembly usually has a storage device such as a hard drive that is connected to a printed circuit board. Conventional assemblies utilize a cable to connect the hard drive to a connector on the printed circuit board. More recently, a fixed form factor has been developed and is commonly referred to as “Serial Advanced Technology Attachment” or “SATA.” In a SATA arrangement, edge finger connectors on a board of a storage device are directly connected to a computer mounted to a printed circuit board.

In a fixed form factor arrangement, a connector is usually mounted on an upper surface of a printed circuit board. The space taken up in a vertical direction equals the height of the printed circuit board plus the height of the connector. The board of the drive is then inserted into the connector. The height of the entire assembly is measured from a lower surface of the printed circuit board to an upper surface of the drive.

In certain arrangements, especially where a number of drives are installed above one another or for mobile computers, it may be required that the vertical space be as small as possible. The vertical space taken up by the printed circuit board, connector, and drive may be too large for such applications.

### BRIEF DESCRIPTION OF THE DRAWINGS

The invention is described by way of examples with reference to the accompanying drawings, wherein:

FIG. 1 is a perspective view of a SATA connector, according to one embodiment of the invention;

FIG. 2 is a side view of the connector;

FIG. 3 is a back view of the connector;

FIG. 4 is a side view illustrating a subassembly of a computer, including the connector, a printed circuit board, and a storage device after the connector is connected to the printed circuit board, but before the storage device is connected to the connector;

FIG. 5 is a top plan view of the computer subassembly before the components are connected to one another;

FIG. 6 is a side view of a connector according to another embodiment of the invention;

FIG. 7 is a perspective view of the connector of FIG. 6;

FIG. 8 is a top plan view of a printed circuit board to which the connector of FIG. 6 can be connected;

FIG. 9 is a side view of a connector according to a further embodiment of the invention;

FIG. 10 is a perspective view of the connector of FIG. 9; and

FIG. 11 is a top plan view illustrating the layout of contacts on an upper and a lower surface of a printed circuit board to which the connector of FIG. 9 can be connected.

### DETAILED DESCRIPTION OF THE INVENTION

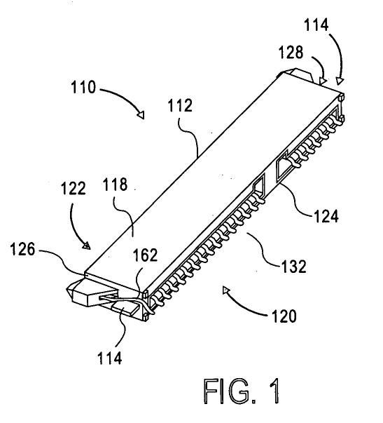

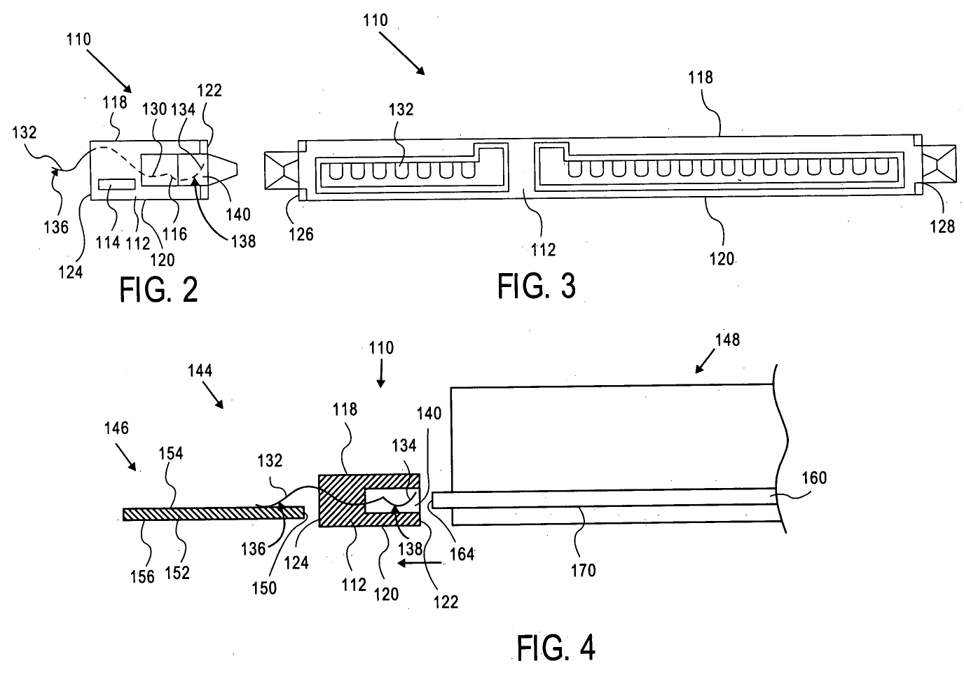

FIGS. 1, 2, and 3 of the accompanying drawings illustrate a SATA connector 110, according to one embodiment of the invention, which includes a connector body 112, retaining formations 114, and springable metal elements 116, jointly allowing the connector 110 to be secured against an edge (as opposed to on top) of a printed circuit board.

The connector body 112 has upper, lower, front, back, left, and right surfaces 118, 120, 122, 124, 126, and 128, respectively. The connector body 112 is typically molded out of an insulative plastics material.

The retaining formations 114 are located on the left and right surfaces 126 and 128, respectively, of the connector body 112. The retaining formations 114 are molded with and made of the same material as the connector body 112.

Each one of the springable metal elements 116 has a central portion 130 secured within the connector body 112, and two opposing end portions forming first and second contacts 132 and 134, respectively. The first contact 132 is located at the back surface 124 of the connector body 112, and the second contact 134 is located at the front surface 122.

The first contact 132 has a lower surface 136 which is curved and located between a horizontal plane of the lower surface 120 and a horizontal plane of the upper surface 118. In its relaxed condition, the lower surface 136 is above an upper surface of the retaining formation 114. The lower surface 136 is depressible in an upward direction against a spring force provided by the first contact 132. The second contact 134 has a lower surface 138. The lower surface 138 is depressible in an upward direction. The lower surface 138 is located above an upper surface of a recess 140 in the front surface 122.

The springable metal elements 116 are located in a single row that extends in a direction from the left surface 126 to the right surface 128. Fifteen of the springable metal elements 116 are in a first group and are spaced equidistantly from one another. Seven of the springable metal elements 116 are located in a second group and are spaced from one another by the same distance as the springable metal elements 116 of the first group. The first and second groups are spaced from one another by approximately five times the distance that the springable metal elements 116 of the first group are spaced from one another.

FIG. 4 illustrates a SATA computer subassembly 144 which includes the connector 110, a printed circuit board 146, and a storage device 148. The configuration of the connector 110 allows for the connector 110 to be located on an edge 150 of a substrate 152 of the printed circuit board 146.

The substrate 152 deflects the lower surface 136 of the first contact 132 in an upward direction, whereafter the connector body 112 is mounted to the substrate 152. In this position, upper and lower surfaces, 154 and 156 respectively, of the substrate 152 are both located above the lower surface 120 of the connector body 112. The surfaces 154 and 156 are also below the upper surface 118 of the connector body 112. The substrate 152 thus does not add any space in a vertical direction in addition to the space taken by the connector body 112.

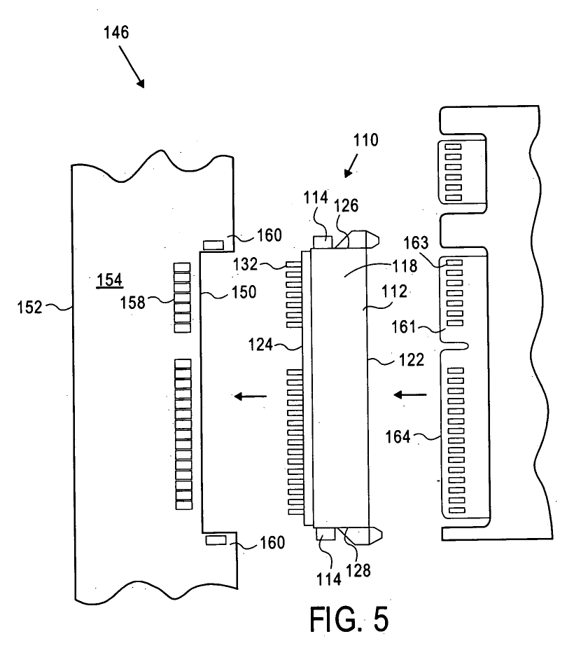

Reference is now made to FIGS. 1 and 5 in combination. The printed circuit board 146 also has a plurality of contacts 158 at the upper surface 154 of the substrate 152. The respective lower surface 136 of each first contact 132 makes contact with a respective one of the contacts 158.

The edge 150 of the substrate 152 is within a cut-away portion of the substrate 152, so that the substrate 152 further has two wings 160 on opposing sides of the edge 150. The wings 160 are positioned on top of the retaining formations 114. The connector 110 further has retaining clips 162 which are also mounted to the connector body 112, and have lower surfaces that make contact with upper surfaces of the wings 160. The retaining formations 114 and retaining clips 162 jointly hold the connector body 112 in a fixed position on the edge 150 of the substrate 152.

The storage device 148 may, for example, be a hard drive. It will be appreciated that a hard drive includes a disk with a medium on which information is stored and a head that can write and read the information to or from the disk. A hard drive also has circuitry for communicating to or from the head, for movement of the head, and rotation of the disk.

The storage device 148 also includes a board 161 and a plurality of edge finger contacts 163 on the board 161. An edge 164 of the board 161 is inserted into the recess 140 of the connector body 112. The second contacts 134 are depressed in an upward direction. Each one of the edge finger contacts 163 slides into contact with a respective lower surface 138 of a respective second contact 134.

After connecting the storage device 148 to the connector 110, the upper surface 154 of the substrate 152 of the printed circuit board 146 is above a lower surface 170 of the board 161. The printed circuit board 146, connector 110, and the board 161 thus fit together in a edge-to-edge relationship. No additional space is taken up in a vertical direction, because two of these components are not located on top of one another.

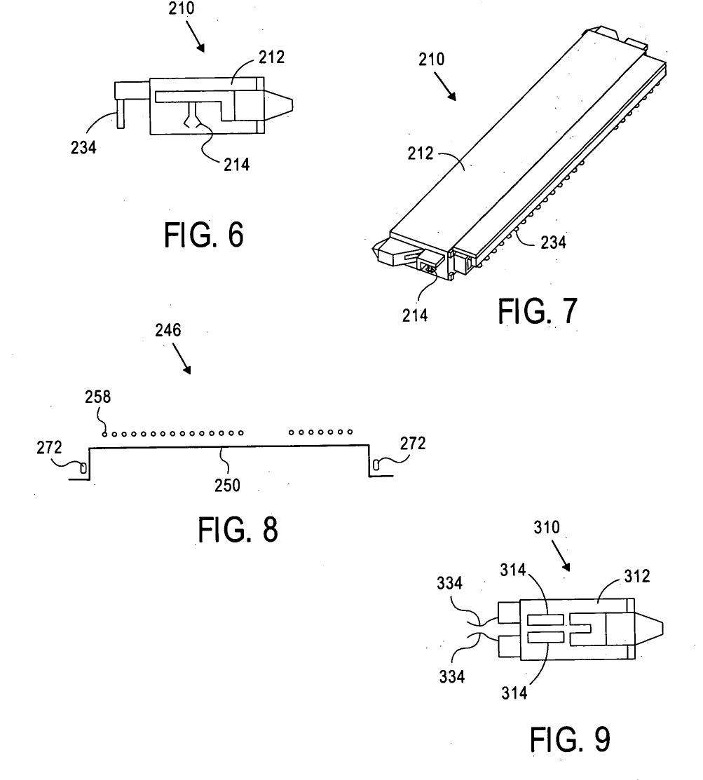

FIGS. 6 and 7 illustrate a connector 210 according to another embodiment of the invention. The connector 210 has a connector body 212, retaining clips 214, and metal elements forming first contacts (not shown) and second contacts 234. Each second contact 234 is a pin that extends in a vertically downward direction. Each retaining clip 214 also extends in a downward direction, and is resiliently depressible in a horizontal direction.

FIG. 8 illustrates a printed circuit board 246 to which the connector 210 can be connected. The printed circuit board 246 has a plurality of downwardly extending plated via contacts 258 and two clip openings 272. Each one of the second contacts 234 is downwardly inserted into a respective one of the via contacts 258. The connector body 212 is then located against an edge 250 of the printed circuit board 246. Each retaining clip 214 is inserted into a respective clip opening 272. Insertion causes the retaining clip 214 to be depressed, and spring back after being fully inserted into the respective clip opening 272.

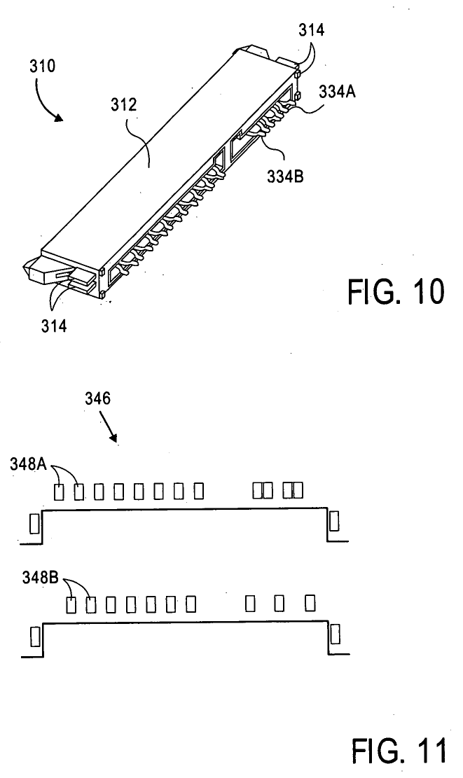

FIGS. 9 and 10 illustrate a connector 310 according to a further embodiment of the invention. The connector 310 has a connector body 312, retaining formations 314, and springable metal elements, each having a first contact (not shown) and a second contact 334. The contacts 334 are located in upper and lower rows. The retaining formations 314 are located above one another on left and right side surfaces of the connector body 312.

FIG. 11 illustrates a printed circuit board 346 to which the connector 312 can be connected. The printed circuit board 346 is the same as the printed circuit board 146 of FIG. 5, except that some of the contacts 348A are located on an upper surface of a substrate of the printed circuit board 346, and some of the contacts 348B are located on the bottom surface. The contacts 334A in the upper row make contact with the contacts 348A on the upper surface, and the contacts 334B in the bottom row make contact with the contacts 348B on the bottom surface. The printed circuit board 346 is pinched between the upper and lower rows of contacts 334A and 334B. The retaining formations 314 simply provide additional alignment for the connector 312 on the printed circuit board 346, whereas the retaining clip 162 of FIG. 1 provides both alignment and structurally secures the connector 110 to the printed circuit board 146.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1. A connector, comprising:
a connector body having upper, lower, front, back, left, and right surfaces;
a first plurality of contacts secured to the connector body, each having a surface at the back surface of the connector body, the surface of the first contact having a curved portion between planes of the upper and lower surfaces of the connector body;
a second plurality of contacts secured to the connector body and electrically connected to the first plurality of contacts, each having a surface at the front surface of the connector body and being depressible against a spring force when making contact with a respective edge finger connector on a board;
retaining formations extending from the left and right surfaces; and
retaining clips mounted to the connector body adjacent the left and right surfaces.

2. The connector of claim 1, wherein the surface of each of the second plurality of contacts is between the planes of the upper and lower surfaces of the connector body.

3. The connector of claim 1, further comprising a retaining formation on the connector body, the retaining formation being shaped to receive a printed circuit board with the surfaces of the first plurality of contacts making contact with contacts on the printed circuit board.

4. The connector of claim 3, wherein upper and lower surfaces of the printed circuit board are both between the planes of the upper and lower surfaces of the connector body.

5. The connector of claim 1, wherein the surfaces of the first plurality of contacts are in two rows above one another.

6. (canceled)

7. A computer subassembly, comprising:
a printed circuit board including a substrate with upper and lower surfaces and a plurality of contacts on the printed circuit board substrate;
a connector secured to the substrate of the printed circuit board, the connector including a connector body having upper, lower, front, back, and right surfaces, the upper surface of the printed circuit board substrate being higher than the lower surface of the connector body, a first plurality of contacts secured to the connector body, each having a surface at the back surface of the connector body and making contact with a surface of a respective one of the printed circuit board contacts, a second plurality of contacts secured to the connector body and electrically connected to the first plurality of contacts, each having a surface at the front surface of the connector body and being depressible against a spring force when making contact with a respective edge finger connector on a board, retaining formations extending from the left and right surfaces, and retaining clips mounted to the connector body adjacent the left and right surfaces.

8. The computer subassembly of claim 7, wherein the lower surface of the substrate of the printed circuit board is above the lower surface of the connector body.

9. The computer subassembly of claim 7, wherein the surface of each of the first plurality of contacts is curved.

10. The computer subassembly of claim 7, further comprising a storage device having a board with upper and lower surfaces, and a plurality of edge finger contacts on the board, making contact with and depressing a respective one of the second contacts of the connector.

11. The computer subassembly of claim 10, wherein the upper surface of the substrate of the printed circuit board is above the lower surface of the board.

12. (canceled)

13. The computer subassembly of claim 7, wherein the surfaces of the first plurality of contacts are in two rows above one another.

14-18. (canceled)
